(19) United States
(12) Patent Application Publication
(10) Pub. No.: US 2015/0365996 A1
(43) Pub. Date: Dec. 17, 2015

(54) ELECTRONIC DEVICE AND METHOD FOR CONTROLLING DATA TRANSMISSION AND RECEPTION WHEN MAKING VOICE CALL

(71) Applicant: Samsung Electronics Co., Ltd., Gyeonggi-do (KR)

(72) Inventors: Sung-Jun LEE, Gyeonggi-do (KR); Hye-Jeong KIM, Gyeonggi-do (KR); Sung-Jin PARK, Seoul (KR)

(73) Assignee: Samsung Electronics Co., Ltd.

(21) Appl. No.: 14/742,235

(22) Filed: Jun. 17, 2015

(30) Foreign Application Priority Data
Jun. 17, 2014 (KR) 10-2014-0073609

(51) Int. Cl. H04W 76/04; H04W 24/10; H04L 12/26

(52) U.S. Cl. CPC H04W 76/048; H04L 43/16; H04W 24/10; H04L 43/0888

(57) ABSTRACT

Methods and devices are provided in which a voice call is made during data transmission and reception to and from an external electronic device. It is determined whether a communication status is sufficient to perform the data transmission and reception while making the voice call. The data transmission and reception is stopped if it is determined that the communication status is not sufficient to perform the data transmission and reception while making the voice call.

### PRIORITY

This application claims priority under 35 U.S.C. §119(a) to a Korean patent application filed in the Korean Intellectual Property Office on Jun. 17, 2014 and assigned Serial No. 10-2014-0073609, the content of which is incorporated herein by reference.

### BACKGROUND OF THE INVENTION

1. Field of the Invention

The present invention relates generally to control of data transmission and reception, and more particularly, to a method and device for controlling data transmission and reception when making a voice call.

2. Description of the Related Art

Most mobile electronic devices can operate on a voice call while also transmitting and receiving data.

When the mobile electronic device receives a request for a voice call while transmitting and receiving data, the mobile electronic device operates the voice call while performing data transmission and reception in the background.

However, when the mobile electronic device transmits and receives data while making the voice call, the mobile electronic device may stop performing data transmissioon and reception in the background if the mobile electronic device enters a waiting state or if the signal quality of the mobile electronic device falls below a threshold level.

If the waiting state is maintained for a long period of time, the mobile electronic device may lose a large amount of data.

Additionally, if data transmission and reception is controlled according to the signal quality of the mobile electronic device, the mobile electronic device may fail to detect a situation in which a voice call is disconnected, and thus disconnect the voice call, although the signal quality of the mobile electronic device is good. Also, the mobile electronic device may stop data transmission and reception in a situation in which a voice call can be maintained, although the signal quality of the mobile electronic device is poor.

### SUMMARY OF THE INVENTION

The present invention has been made to address at least the above problems and/or disadvantages and to provide at least the advantages described below. Accordingly, an aspect of the present invention provides an electronic device and a method for controlling data transmission and reception when making a voice call.

In accordance with an aspect of the present invention, an electronic device is provided that includes a communication interface configured to communicate with an external electronic device. The electronic device also includes a control module configured to determine whether a communication status is sufficient to perform data transmission and reception to and from the external electronic device while making a voice call, and to stop the data transmission and reception if the control module determines that the communication status is not sufficient to perform the data transmission and reception while making the voice call.

In accordance with another aspect of the present invention, a method of using an electronic device is provided. A voice call is made during data transmission and reception to and from an external electronic device. It is determined whether a communication status is sufficient to perform the data transmission and reception while making the voice call. The data transmission and reception is stopped if it is determined that the communication status is not sufficient to perform the data transmission and reception while making the voice call.

In accordance with another aspect of the present invention, a computer-readable recording medium is provided storing computer-readable instructions, recorded with a program for executing operations of: making a voice call during data transmission and reception to and from an external electronic device; determining whether a communication status is sufficient to perform the data transmission and reception while making the voice call; and stopping the data transmission and reception if the communication status is not sufficient to perform the data transmission and reception while making the voice call.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a diagram illustrating a network environment including an electronic device, according to an embodiment of the present invention;

FIG. 2 is a block diagram of a control module included in an electronic device, according to an embodiment of the present invention;

FIG. 3 is a flowchart illustrating a method of controlling data transmission and reception when making a voice call, according to an embodiment of the present invention;

FIG. 4 is a flowchart illustrating a method of controlling data transmission and reception when making a voice call, according to an embodiment of the present invention;

FIG. 5 is a flowchart illustrating a method of controlling data transmission and reception when making a voice call, according to an embodiment of the present invention;

FIG. 6 is a flowchart illustrating a method of controlling data transmission and reception when making a voice call, according to an embodiment of the present invention;

FIG. 7 is a flowchart illustrating a method of controlling data transmission and reception when making a voice call, according to an embodiment of the present invention;

FIG. 8 is a flowchart illustrating a method of controlling data transmission and reception when making a voice call, according to an embodiment of the present invention; and

FIG. 9 is a block diagram of an electronic device, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

It will be understood that the terms “comprises”, “may comprise”, “includes” and/or “may include”, when used herein, specify the presence of stated functions, operations, and/or components, but do not preclude the presence or addition of one or more other functions, steps, and/or components. It will be further understood that the terms “comprises” or “has”, when used herein, specify the presence of stated features, integers, steps, operations, elements, components and/or groups thereof, but do not preclude the presence or addition of one or more other features, integers, steps, operations, elements, components, and/or groups thereof.

As used herein, the term “or” includes any and all combinations of one or more of the associated listed items. For example, “A and/or B” may include A, B, or both A and B.

It will be understood that, although the terms first, second, etc. may be used herein to describe various components, these components should not be limited by these terms. For example, the terms do not limit the order and/or importance of the components. These terms are only used to distinguish one component from another. For example, a first user device and a second user device indicate different user devices. Additionally, a first component could be termed a second component, and, similarly, a second component could be termed a first component, without departing from the scope of the present invention.

It will be understood that when a component is referred to as being “connected” or “coupled” to another component, it can be directly connected or coupled to the other component, or intervening components may be present. In contrast, when a component is referred to as being “directly connected” or “directly coupled” to another component, there are no intervening components present. The terminology used herein is for the purpose of describing particular embodiments only and is not intended to limit the embodiments of the present invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

An electronic device, according to an embodiment of the present invention, may have a communication capability. For example, the electronic device may be embodied as at least one of a smart phone, a tablet Personal Computer (PC), a mobile phone, a video phone, an e-Book reader, a desktop PC, a laptop PC, a Netbook computer, a Personal Digital Assistant (PDA), a Portable Multimedia Player (PMP), an MP3 player, mobile medical equipment, a camera, or a wearable device (for example, a Head-Mounted-Device (HMD) such as electronic glasses, electronic clothes, an electronic bracelet, an electronic necklace, an electronic Appcessory, an electronic tattoo, or a smart watch).

According to an embodiment of the present invention, the electronic device may be embodied as a smart home appliance with communication capacity. The smart home appliance may be at least one of a Television (TV), a Digital Versatile Disc (DVD) player, audio equipment, a refrigerator, an air conditioner, an oven, a microwave, a washing machine, an air cleaner, a set-top box, a TV box, a game console, an electronic dictionary, a camcorder, or an electronic album.

According to an embodiment of the present invention, the electronic device may be embodied as at least one of various medical equipment (for example, Magnetic Resonance Angiography (MRA), Magnetic Resonance Imaging (MRI), Computed Tomography (CT), a medical camcorder, ultrasonic equipment, and the like), a navigation device, a Global Positioning System (GPS) receiver, an Event Data Recorder (EDR), a Flight Data Recorder (FDR), an automotive infotainment device, electronic equipment for ship (for example, marine navigation device, gyro compass, and the like), avionics, security equipment, a head unit for vehicle, an industrial or home robot, an Automatic Teller Machine (ATM) of a bank, or a Point of Sales (PoS) of store.

According to an embodiment of the present invention, the electronic device may be embodied as at least one of furniture or part of building/structure with display capability, an electronic board, an electronic signature receiving device, a projector, or various metering equipment (for example, water, electricity, gas, or waves metering equipment). The electronic device may be embodied as one of the aforementioned devices or a combination of one or more of the aforementioned devices. Also, the electronic device may be a flexible device. It will be apparent to those of ordinary skill in the art that the electronic device, according to an embodiment of the present invention, is not limited to the aforementioned devices.

Hereinafter, according to an embodiment of the present invention, an electronic device is described with reference to the accompanying drawings. Herein, the term “user” may indicate a person or an apparatus (for example, an intelligent electronic device) that uses the electronic device.

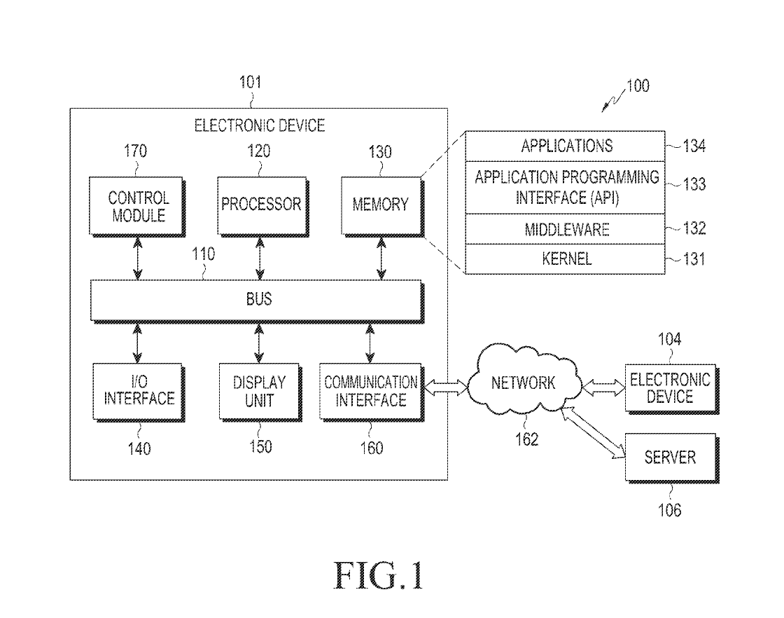

FIG. 1 is a diagram illustrating a network environment including an electronic device, according to an embodiment of the present invention. Referring to FIG. 1, an electronic device 101 includes a bus 110, a processor 120, a memory 130, an input/output interface 140, a display unit 150, a communication interface 160, and a control module 170.

The bus 110 may be a circuit used to connect the aforementioned components to each other, and to allow communications (for example, transmission of control messages) between the aforementioned components.

The processor 120 may receive commands from the aforementioned components (for example, the memory 130, the input/output interface 140, the display unit 150, the communication interface 160, or the control module 170) through the bus 110, interpret the received commands, and perform operations or data processing according to the interpreted commands.

The memory 130 may store commands or data received from or created by the processor 120 or the components (for example, the input/output interface 140, the display unit 150, the communication interface 160, or the control module 170). The memory 130 includes programming modules, such as, for example, a kernel 131, middleware 132, an Application Programming Interface (API) 133, an application 134, and the like. Each of the programming modules may be software, firmware, hardware, or a combination of two or more of the aforementioned options.

The kernel 131 may control or manage system resources (for example, the bus 110, the processor 120, or the memory 130), which the other programming modules (for example, the middleware 132, the API 133, or the application 134) use to execute their operations or functions. Also, the kernel 131 may provide an interface to enable the middleware 132, the API 133, or the application 134 to access individual components of the electronic device 101 and to control or manage the components.

The middleware 132 is an intermediary that enables the API 133 or the application 134 to communicate with the kernel 131 to receive/transmit data from/to the kernel 131. Also, when operation requests are received from the application 134 (or a plurality of applications 134), the middleware 132 may control (for example, schedule or load balance) the operation requests, for example, by allocating a priority for use of a system resource (for example, the bus 110, the processor 120, or the memory 130) of the electronic device 101 to the application 134 (or at least one of the plurality of applications 134).

The API 133 is an interface that enables the application 134 to control functions that are provided by the kernel 131 or the middleware 132. The API 133 may include at least one interface or function (for example, commands) used for, for example, file control, window control, image processing, characters control, and the like.

According to an embodiment of the present invention, the application 134 may be a Short Message Service (SMS)/Multimedia Messaging Service (MMS) application, an E-mail application, a calendar application, an alarm application, a health care application (for example, an application of measuring a workout or blood sugar), or an environmental information application (for example, an application of providing information about pressure, humidity, temperature, etc.). Additionally or alternatively, the application 134 may be an application related to data exchange between the electronic device 101 and an external electronic device (for example, an external electronic device 104). The application related to data exchange may be, for example, a notification relay application to transfer specific information to the external electronic device, or a device management application to manage the external electronic device.

For example, the notification relay application may relay notification information generated by another application (for example, an SMS/MMS application, an E-mail application, a health care application, or an environmental information application) of the electronic device 101, to the external electronic device 104. Additionally or alternatively, the notification relay application may receive notification information from the external electronic device 104, and provide the notification information to a user. The device management application may turn on/off functions of the external electronic device 104 that communicates with the electronic device 101, or functions of at least one component of the external electronic device 104, may adjust the brightness (or, resolution) of a display, or may manage (for example, install, delete, or update) an application that is executed on the external electronic device 104 or a service (for example, a call service or a message service) that is provided by the external electronic device 104.

According to an embodiment of the present invention, the application 134 may include an application designated according to an attribute (for example, the kind of device) of the external electronic device 104. For example, if the external electronic device 104 is an MP3 player, the application 134 may include an application for playing music. Likewise, if the external electronic device 104 is mobile medical equipment, the application 134 may include an application related to health-care. According to an embodiment of the present invention, the application 134 may include at least one of an application designated by the electronic device 101 and an application received from a server 106 or the external electronic device 104.

The input/output interface 140 may transfer a command or data received from a user through an input/output device (for example, a sensor, a keyboard, or a touch screen) to the processor 120, the memory 130, the communication interface 160, or the control module 170, for example, through the bus 110. For example, the input/output interface 140 may provide data about a user's touch input received through a touch screen to the processor 120. Also, the input/output interface 140 may output a command or data received from the processor 120, the memory 130, the communication interface 160, or the control module 170, for example, via the bus 110, through an input/output device (for example, a speaker or a display). For example, the input/output interface 140 may output voice data processed by the processor 120, through a speaker, for a user.

The display unit 150 may display various types of information (for example, multimedia data or text data) for a user.

The communication interface 160 enables the electronic device 101 to communicate with the external electronic device 104 or the server 106. For example, the communication interface 160 may connect to a network 162 through wired or wireless communication to communicate with the external electronic device 104. The wireless communication may include at least one of Wireless Fidelity (WiFi), Bluetooth (BT), Near Field Communication (NFC), Global Positioning System (GPS), or cellular communication (for example, Long-Term Evolution (LTE), Long-Term Evolution Advanced (LTE-A), Code Division Multiple Access (CDMA), Wideband Code Division Multiple Access (WCDMA), Universal Mobile Telecommunications System (UMTS), Wireless Broadband (WiBro), Global System for Mobile Communications (GSM), and the like). The wired communication may include at least one of a Universal Serial Bus (USB), a High Definition Multimedia Interface (HDMI), Recommended Standard 232 (RS-232), or a Plain Old Telephone Service (POTS).

According to an embodiment of the present invention, the network 162 may be a telecommunications network. The telecommunications network may include at least one of a computer network, the Internet, the Internet of Things (IoT), or a telephone network. According to an embodiment of the present invention, a protocol (for example, a transport layer protocol, a data link protocol, or a physical layer protocol) for communication between the electronic device 101 and the external electronic device 104 may be supported by at least one of the application 134, the API 133, the middleware 132, the kernel 131, the communication interface 160, or the control module 170.

The control module 170 may process at least one piece of information acquired from the other components (for example, the processor 120, the memory 130, or the communication interface 160), and provide the processed information to a user through various methods. For example, the control module 170 may make a voice call according to a request for making the voice call, during data transmission and reception, using the processor 120, or independently from the processor 120. If the voice call is made, the control module 170 may perform data transmission and reception in the background.

If the electronic device 101 enters a waiting state, the control module 170 may determine whether a communication status of the network 162 is sufficient to perform data transmission and reception while making the voice call. If the control module 170 determines that the communication status of the network 162 is sufficient to perform the data transmission and reception while making the voice call, the control module 170 maintains the current status. If the control module 170 determines that the communication status of the network 162 is not sufficient to perform data transmission and reception while making the voice call, the control module 170 stops data transmission and reception. In an embodiment of the present invention, the waiting state may be a state in which a display of the electronic device 101 is turned off and minimum power is supplied to the electronic device 101 to operate only essential components. Also, when the electronic device 101 does not enter the waiting state, the control module 170 may determine whether the communication status of the network 162 is sufficient to perform data transmission and reception while making the voice call.

For example, the control module 170 may determine whether a time taken to transmit data to the external electronic device 104 and then receive, from the external electronic device 104, an acknowledgement (ACK) response message notifying that the data has been received, exceeds a predetermined threshold time. Also, the control module 170 may determine whether the number of times that a negative acknowledgement (NACK) response message, notifying that no data has been received after the data has been transmitted to the external electronic device 104, is received from the external electronic device 104 is less than or equal to a predetermined threshold number of times. Accordingly, the control module 170 determines whether the communication status of the network 162 is sufficient to perform data transmission and reception while making the voice call. In an embodiment of the present invention, the predetermined threshold time may be an arbitrary time set to determine a time taken to receive an ACK response message, and the predetermined threshold number of times may be an arbitrary number of times set to determine the number of times that a NACK response message is received.

If the control module 170 determines that the time taken to receive the ACK response message does not exceed the predetermined threshold time, the control module 170 determines that the communication status is sufficient to perform data transmission and reception while making the voice call. Also, if the control module 170 determines that the number of times that the NACK response message is received is less than or equal to the predetermined number of times, the control module 170 determines that the communication status is sufficient to perform the data transmission and reception while making the voice call.

The control module 170 may transmit a disconnection request message for stopping data transmission and reception, to the external electronic device 104, in order to stop data transmission and reception to and from the external electronic device 104. In an embodiment of the present invention, the control module 170 may stop paging related to data transmission and reception.

After the control module 170 determines whether the signal quality of the network 162 is sufficient to perform data transmission and reception by monitoring a channel state of the network 162, the control module 170 may resume data transmission and reception if the control module 170 determines that the signal quality of the network 162 is sufficient to perform the data transmission and reception. If the control module 170 determines that the signal quality of the network 162 is not sufficient to perform data transmission and reception, the control module 170 may stop data transmission and reception, and then determine whether the signal quality of the network 162 is sufficient to perform the data transmission and reception at regular time intervals.

For example, the control module 170 may determine whether the processing speed of the network 162 is greater than a threshold speed and/or whether a throughput of the network 162 is greater than a threshold throughput. If the control module 170 determines that the processing speed of the network 162 is greater than the threshold speed or that the throughput of the network 162 is greater than the threshold throughput, the control module 170 may determine that the signal quality of the network 162 is sufficient to perform data transmission and reception. Also, if the control module 170 determines that the processing speed of the network 162 is greater than the threshold speed and that the throughput of the network 162 is greater than the threshold throughput, the control module 170 may determine that the signal quality of the network 162 is sufficient to perform data transmission and reception. In an embodiment of the present invention, the threshold speed may be an arbitrary speed set to determine the processing speed of the network 162, and the threshold throughput may be an arbitrary throughput set to determine the throughput of the network 162.

In an embodiment of the present invention, after resuming data transmission and reception, the control module 170 may resume paging related to data transmission and reception.

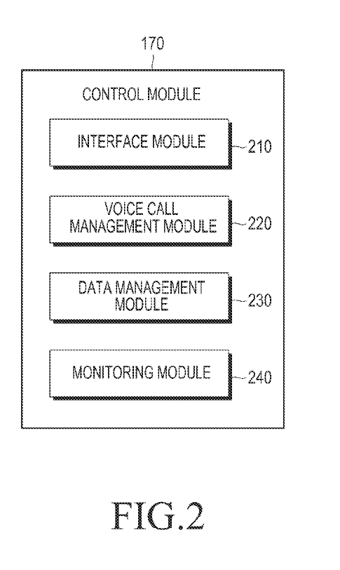

FIG. 2 is a block diagram of the control module 170 of the electronic device 101, according to an embodiment of the present invention.

Referring to FIG. 2, the control module 170 includes an interface module 210, a voice call management module 220, a data management module 230, and a monitoring module 240.

The interface module 210 may perform data transmission and reception to and from an external electronic device through the network 162 of FIG. 1, and may receive an ACK or NACK response message from the external electronic device. Also, the interface module 210 may transmit a disconnection request message to the external electronic device.

The voice call management module 220 may manage, for example, a voice call connection.

The data management module 230 may manage, for example, data transmission and reception. If data transmission and reception is stopped, the data management module 230 may generate a disconnection request message.

The monitoring module 240 may determine whether a communication status of the network 162 is sufficient to perform data transmission and reception while making a voice call, if the voice call is made during data transmission and reception. If the monitoring module 240 determines that the communication status of the network 162 is sufficient to perform data transmission and reception while making the voice call, the monitoring module 240 may maintain a current status. If the monitoring module 240 determines that the communication status of the network 162 is not sufficient to perform data transmission and reception while making the voice call, the monitoring module 240 may stop data transmission and reception. Also, if the electronic device 101 enters a waiting state when a voice call is made during data transmission and reception, the monitoring module 240 may determine whether the communication status of the network 162 is sufficient to perform data transmission and reception while making the voice call. Such determinations may be made by the monitoring module 240 in accordance with the examples provided above with respect to FIG. 1. For example, in order to determine whether the communication status of the network 162 is sufficient to perform the data transmission and reception while making the voice call, the monitoring module 240 may determine whether a time taken to transmit data and then receive a response message ACK does not exceed a predetermined threshold time, or whether the number of times by which a response message NACK is received after the data is transmitted is less than or equal to a predetermined threshold number of times. If the monitoring module 240 determines that the time taken to receive a response message ACK does not exceed the predetermined threshold time, or that the number of times that the response message NACK is received is less than or equal to the predetermined threshold number of times, the monitoring module 240 may determine that the communication status of the network 162 is sufficient to perform the data transmission and reception while making the voice call.

The monitoring module 240 may transmit the disconnection request message generated by the data management module 230 to the external electronic device through the interface module 210, and stop paging related to the data transmission and reception. The monitoring module 240 may monitor a channel state of the network 162 to determine whether the signal quality of the network 162 is sufficient to perform data transmission and reception. If the monitoring module 240 determines that the signal quality of the network 162 is sufficient to perform data transmission and reception, the monitoring module 240 may resume data transmission and reception, and if the monitoring module 240 determines that the signal quality of the network 162 is not sufficient to perform data transmission and reception, the monitoring unit 240 may stop data transmission and reception. For example, the monitoring module 240 may resume data transmission and reception, and also resume paging related to the data transmission and reception.

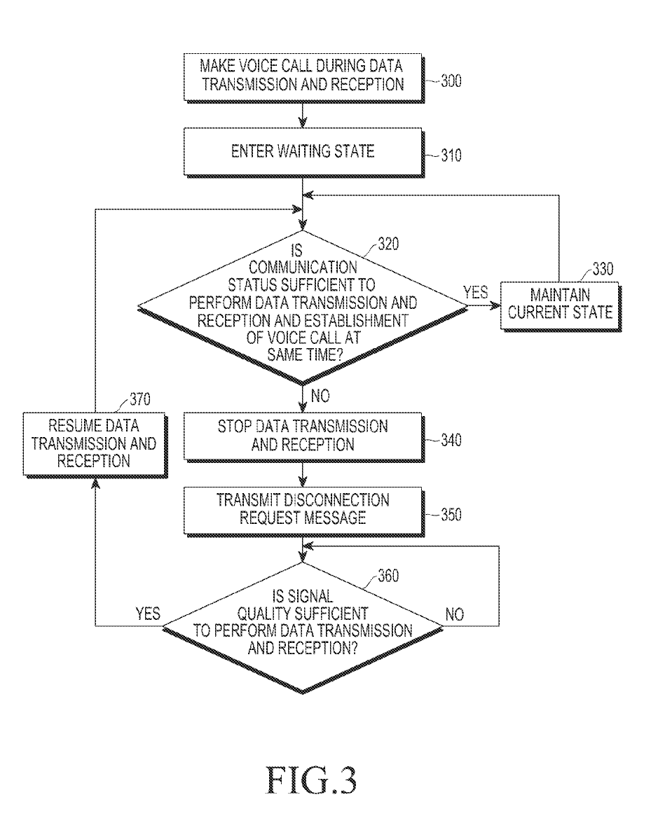

FIG. 3 is a flowchart illustrating a method of controlling data transmission and reception when making a voice call, according to an embodiment of the present invention.

In step 300, the control module 170 makes a voice call during data transmission and reception to and from an external electronic device. In step 310, the electronic device 101 enters a waiting state. In step 320, the control module 170 determines whether a communication status of the network 162 is sufficient to perform data transmission and reception while making the voice call. If the control module 170 determines that the communication status of the network 162 is sufficient to perform data transmission and reception while making the voice call, the control module 170 maintains a current state, in step 330, before returning to step 320 to determine whether the communication status of the network 162 is sufficient to perform data transmission and reception while making the voice call.

If the control module 170 determines that the communication status of the network 162 is not sufficient to perform data transmission and reception while making the voice call, the control module 170 stops data transmission and reception to and from the external electronic device, in step 340, and transmits a disconnection request message to the external electronic device, in step 350.

In step 360, the control module 170 determines whether the signal quality of the network 162 is sufficient to perform data transmission and reception to and from the external electronic device. If the control module 170 determines that the signal quality of the network 162 is not sufficient to perform data transmission and reception to and from the external electronic device, the control module 170 repeats step 360. For example, the control module 170 may determine whether a processing speed of the network 162 is greater than a threshold speed and/or whether a throughput of the network 162 is greater than a threshold throughput. If the control module 170 determines that the processing speed of the network 162 is greater than the threshold speed or that the throughput of the network 162 is greater than the threshold throughput, the control module 170 may determine that the signal quality of the network 162 is sufficient to perform the data transmission and reception. Also, if the control module 170 determines that the processing speed of the network 162 is greater than the threshold speed and that the throughput of the network 162 is greater than the threshold throughput, the control module 170 may determine that the signal quality of the network 162 is sufficient to perform the data transmission and reception.

If the control module 170 determines that the signal quality of the network is sufficient to perform data transmission and reception to and from the external electronic device, the control module 170 resumes data transmission and reception to and from the external electronic device, in step 370, and then returns to step 320 to determine whether the communication status of the network 162 is sufficient to perform data transmission and reception while making the voice call.

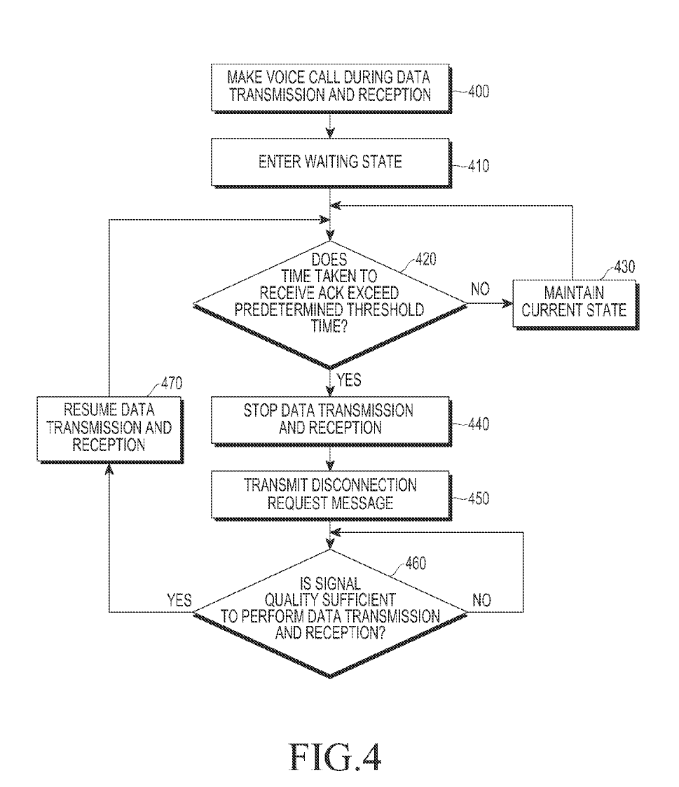

FIG. 4 is a flowchart illustrating a method of controlling data transmission and reception when making a voice call, according to an embodiment of the present invention.

In step 400, the control module 170 makes a voice call during data transmission and reception to and from an external electronic device. In step 410, the electronic device 101 enters a waiting state. In step 420, the control module 170 determines whether a time taken to receive an ACK response message from the external electronic device exceeds a predetermined threshold time.

If the control module 170 determines that the time taken to receive the ACK response message from the external electronic device does not exceed the threshold time, the control module 170 maintains a current state, in step 430, and then returns to step 420 to determine whether a time taken to receive an ACK response message from the external electronic device exceeds the threshold time.

If the control module 170 determines that the time taken to receive the ACK response message from the external electronic device exceeds the threshold time, the control module 170 stops data transmission and reception from and to the external electronic device, in step 440, and transmits a disconnection request message to the external electronic device, in step 450.

In step 460, the control module 170 determines whether signal quality of the network 162 is sufficient to perform data transmission and reception to and from the external electronic device. If the control module 170 determines that the signal quality of the network 162 is not sufficient to perform data transmission and reception to and from the external electronic device, the control module 170 repeats step 460 and determines whether the signal quality of the network 162 is sufficient to perform data transmission and reception, while maintaining the state in which data transmission and reception is stopped.

If the control module 170 determines that the signal quality of the network 162 is sufficient to perform data transmission and reception to and from the external electronic device, the control module 170 resumes data transmission and reception to and from the external electronic device, in step 470, and then returns to step 420 to determine whether the communication status of the network 162 is sufficient to perform data transmission and reception while making the voice call.

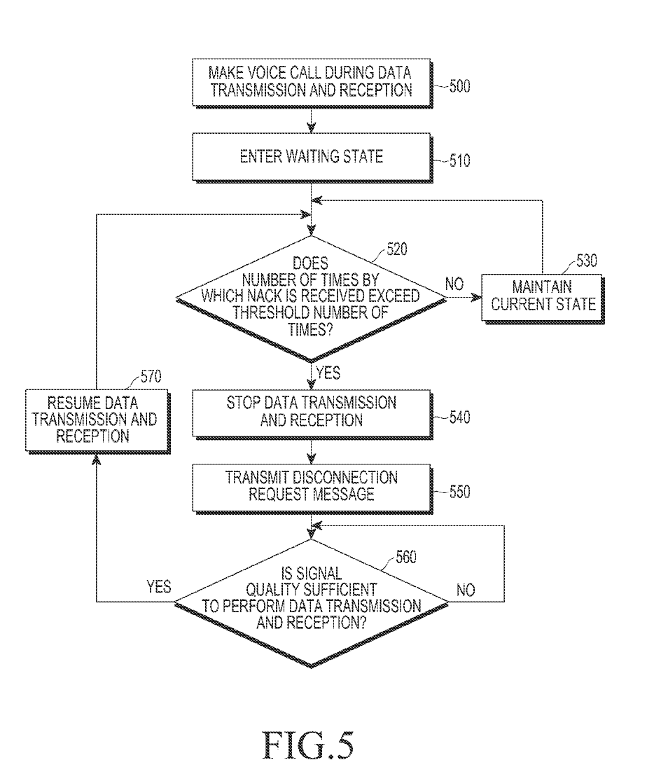

FIG. 5 is a flowchart illustrating a method of controlling data transmission and reception when making a voice call, according to an embodiment of the present invention.

In step 500, the control module 170 makes a voice call during data transmission and reception to and from an external electronic device. In step 510, the electronic device 101 enters a waiting state. In step 520, the control module 170 determines whether the number of times that a NACK response message is received from the external electronic device exceeds a threshold number of times. If the control module 170 determines that the number of times that a NACK response message is received does not exceed the threshold number of times, the control module 170 maintains a current state, in step 530, and then returns to step 520 to determine whether the number of times that a NACK response message NACK is received exceeds the threshold number of times.

If the control module 170 determines that the number of times that a NACK response message is received exceeds the threshold number of times, the control module 170 stops the data transmission and reception to and from the external electronic device, in step 540, and transmits a disconnection request message to the external electronic device, in step 550.

In step 560, the control module 170 determines whether the signal quality of the network 162 is sufficient to perform data transmission and reception to and from the external electronic device. If the control module 170 determines that the signal quality of the network 162 is not sufficient to perform data transmission and reception to and from the external electronic device, the control module 170 repeats step 560 to determine whether the signal quality of the network 162 is sufficient to perform the data transmission and reception, while data transmission and reception is stopped.

If the control module 170 determines that the signal quality of the network 162 is sufficient to perform data transmission and reception to and from the external electronic device, the control module 170 resumes data transmission and reception to and from the external electronic device, in step 570, and then returns to step 520 to determine whether the communication status of the network 162 is in a good condition.

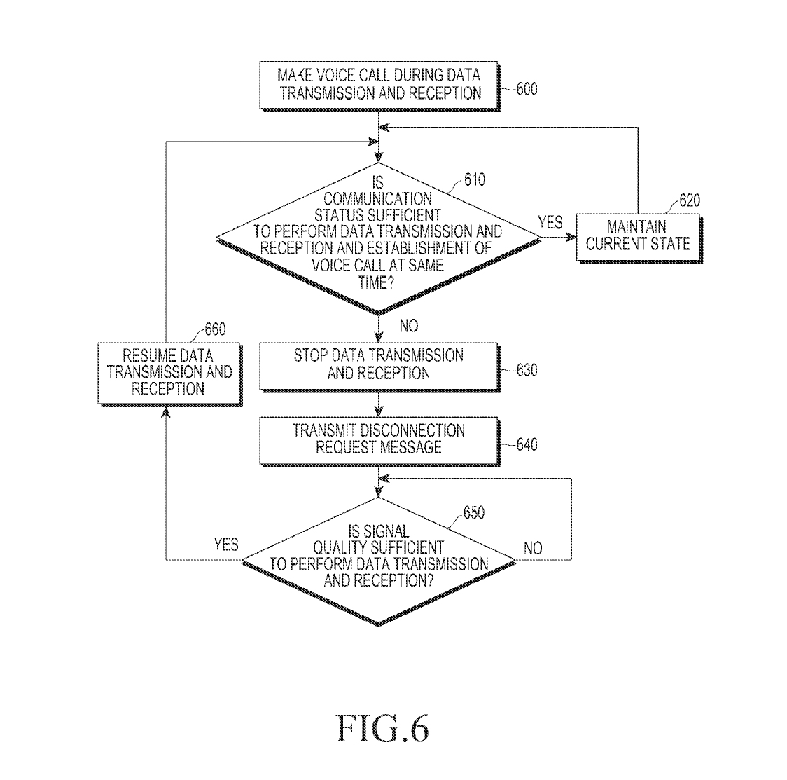

FIG. 6 is a flowchart illustrating a method of controlling data transmission and reception when making a voice call, according to an embodiment of the present invention.

In step 600, the control module 170 makes a voice call during data transmission and reception to and from an external electronic device. In step 610, the control module 170 determines whether a communication status of the network 162 is sufficient to perform data transmission and reception while making the voice call. If the control module 170 determines that the communication status of the network 162 is sufficient to perform data transmission and reception while making the voice call, the control module 170 maintains a current state, in step 620, and then returns to step 610 to determine whether the communication status of the network 162 is sufficient to perform data transmission and reception while making the voice call.

If the control module 170 determines that the communication status of the network 162 is not sufficient to perform data transmission and reception while making the voice call, the control module 170 stops data transmission and reception from and to the external electronic device, in step 630, and transmits a disconnection request message to the external electronic device, in step 640.

In step 650, the control module 170 determines whether the signal quality of the network 162 is sufficient to perform data transmission and reception to and from the external electronic device. If the control module 170 determines that the signal quality of the network 162 is not sufficient to perform data transmission and reception, the control module 170 repeats step 650 to determine whether the signal quality of the network 162 is sufficient to perform the data transmission and reception, while maintaining the state in which the data transmission and reception is stopped.

If the control module 170 determines that the signal quality of the network 162 is sufficient to perform data transmission and reception, the control module 170 resumes data transmission and reception to and from the external electronic device, in step 660, and returns to step 610 to determine whether the communication status of the network 162 is sufficient to perform data transmission and reception while making the voice call.

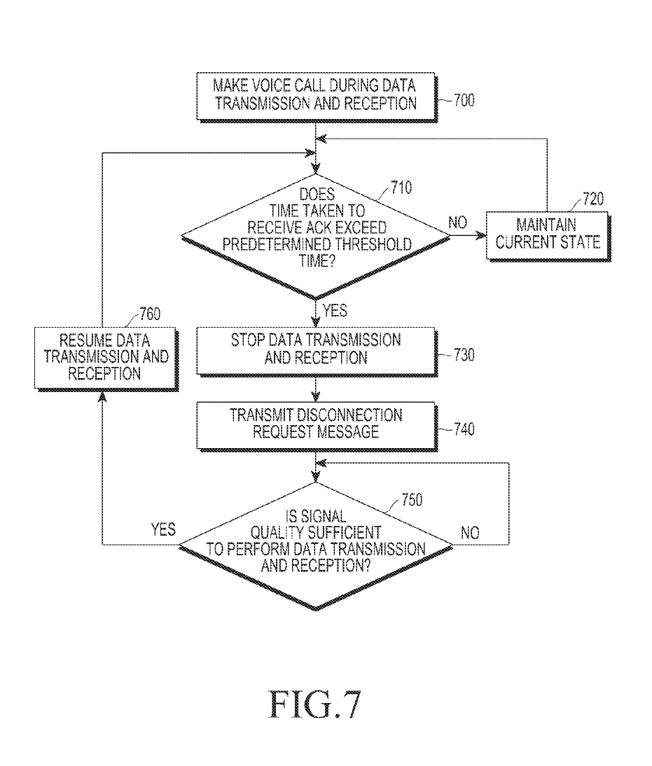

FIG. 7 is a flowchart illustrating a method of controlling data transmission and reception when making a voice call, according to an embodiment of the present invention.

In step 700, the control module 170 makes a voice call during data transmission and reception to and from an external electronic device. In step 710, the control module 170 determines whether a time taken to receive an ACK response message from the external electronic device exceeds a predetermined threshold time.

If the control module 170 determines that the time taken to receive the ACK response message from the external electronic device does not exceed the predetermined threshold time, the control module 170 maintains a current state, in step 720, and then returns to step 710 to determine whether a time taken to receive an ACK response message from the external electronic device exceeds the predetermined threshold time.

If the control module 170 determines that the time taken to receive the ACK response message from the external electronic device exceeds the predetermined threshold time, the control module 170 stops data transmission and reception to and from the external electronic device, in step 730, and transmits a disconnection request message to the external electronic device, in step 740.

In step 750, the control module 170 determines whether the signal quality of the network 162 is sufficient to perform data transmission and reception to and from the external electronic device. If the control module 170 determines that the signal quality of the network 162 is not sufficient to perform data transmission and reception to and from the external electronic device, the control module 170 returns to step 750 to determine whether the signal quality of the network 162 is sufficient to perform the data transmission and reception, while data transmission and reception is stopped.

If the control modules determines that the signal quality of the network 162 is sufficient to perform data transmission and reception to and from the external electronic device, the control module 170 resumes data transmission and reception to and from the external electronic device, in step 760, and then returns to step 710 to determine whether the communication status of the network 162 is sufficient to perform data transmission and reception while making the voice call.

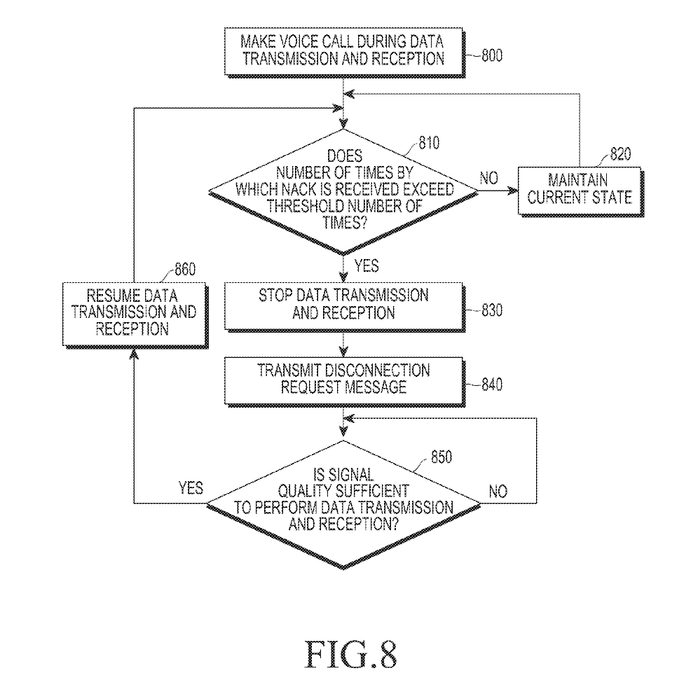

FIG. 8 is a flowchart illustrating a method of controlling data transmission and reception when making a voice call, according to an embodiment of the present invention.

In step 800, the control module 170 makes a voice call during data transmission and reception to and from an external electronic device. In step 810, the control module 170 determines whether the number of times that a NACK response message is received from the external electronic device exceeds a predetermined threshold number of times. If the control module 170 determines that the number of times that a NACK response message is received does not exceed the predetermined threshold number of times, the control module 170 maintains a current state, in step 820, and then returns to step 810 to determine whether the number of times that a NACK response message is received exceeds the predetermined threshold number of times.

If the control module 170 determines that the number of times that a NACK response message is received exceeds the predetermined threshold number of times, the control module 170 stops data transmission and reception to and from the external electronic device, in step 830, and transmits a disconnection request message to the external electronic device, in step 840.

In step 850, the control module 170 determines whether the signal quality of the network 162 is sufficient to perform data transmission and reception to and from the external electronic device. If the control module 170 determines that the signal quality of the network 162 is not sufficient to perform data transmission and reception to and from the external electronic device, the control module 170 repeats step 850 and determines whether the signal quality of the network 162 is sufficient to perform data transmission and reception to and from the external electronic device, while maintaining the state in which data transmission and reception is stopped.

If the control module 170 determines that the signal quality of the network 162 is sufficient to perform data transmission and reception to and from the external electronic device, the control module 170 resumes data transmission and reception to and from the external electronic device, in step 860, and then returns to step 810 to determine whether the communication status of the network 162 is in a good condition.

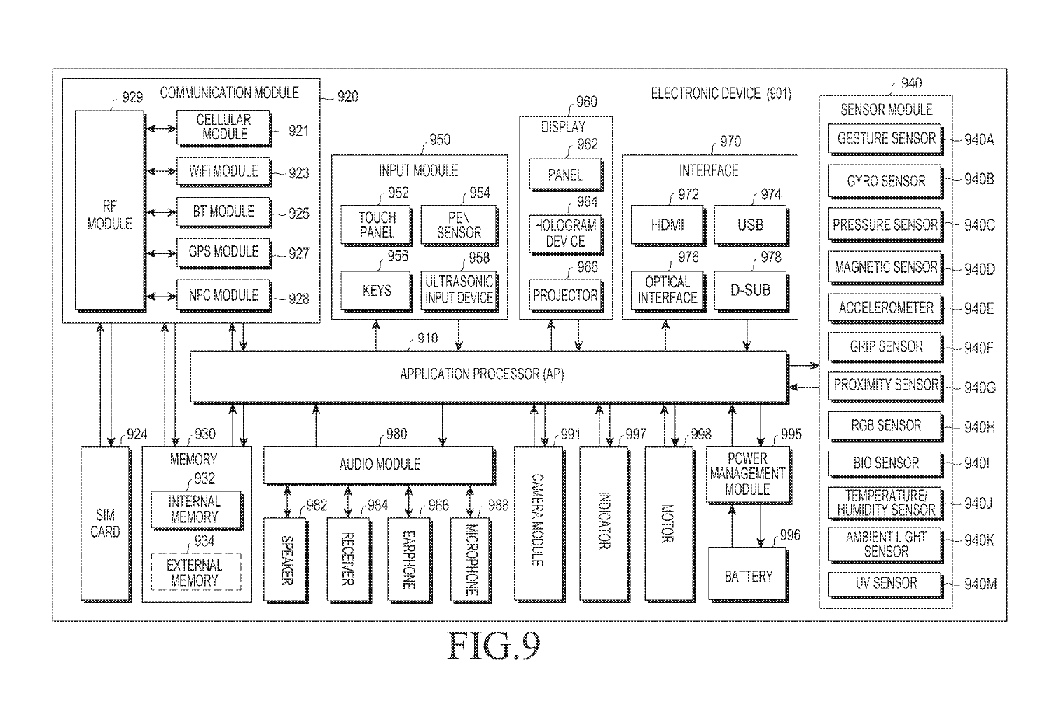

FIG. 9 is a block diagram illustrating an electronic device, according to an embodiment of the present invention. An electronic device 901 may configure the entire or a part of the electronic device 101 of FIG. 1. Referring to FIG. 9, the electronic device 901 includes at least one Application Processor (AP) 910, a communication module 920, a Subscriber Identification Module (SIM) card 924, a memory 930, a sensor module 940, an input module 950, a display 960, an interface 970, an audio module 980, a camera module 991, a power management module 995, a battery 996, an indicator 997, and a motor 998.

The AP 910 may drive Operating System (OS) or an application program to control a plurality of hardware or software components connected to the AP 910, and perform processing and operations of various data, including multimedia data. The AP 910 may be implemented as System on Chip (SoC). According to an embodiment of the present invention, the AP 910 may further include a GPU.

The communication module 920 (for example, the communication interface 160 of FIG. 1) may perform data transmission and reception for communication between the electronic device 901 (for example, the electronic device 101) and other electronic devices (for example, the external electronic device 104 or the server 106 of FIG. 1) connected to the electronic device 901 through a network. According to an embodiment of the present invention, the communication module 920 may include a cellular module 921, a WiFi module 923, a BT module 925, a GPS module 927, a NFC module 928, and a Radio Frequency (RF) module 929.

The cellular module 921 may provide a voice call, a video call, a message service, or an Internet service through a communication network (for example, LTE, LTE-A, CDMA, WCDMA, UMTS, WiBro, or GSM). Also, the cellular module 921 may identify and authenticate the electronic device 901 in a communication network, using a subscriber identification module (for example, the SIM card 924). According to an embodiment of the present invention, the cellular module 921 may perform at least a portion of the functions that can be provided by the AP 910. For example, the cellular module 921 may perform at least a portion of a multimedia control function.

According to an embodiment of the present invention, the cellular module 921 may include a Communication Processor (CP). Also, the cellular module 921 may be implemented as SoC. In FIG. 9, components, such as the cellular module 921 (for example, CP), the memory 930, or the power management module 995, are shown as separate components, however, according to an embodiment of the present invention, the AP 910 may be implemented to include at least a portion (for example, the cellular module 921) of the aforementioned components.

According to an embodiment of the present invention, the AP 910 or the cellular module 921 (for example, CP) may load a command or data received from at least one of a non-volatile memory or another component connected to the AP 910 or the cellular module 921 (for example, CP), in a volatile memory, and then process the command or data. Also, the AP 910 or the cellular module 921 may store data received from or created by at least one other component, in a non-volatile memory.

The WiFi module 923, the BT module 925, the GPS module 927, or the NFC module 928 may include a processor to process data that is received or transmitted through the corresponding module. In FIG. 9, the cellular module 921, the WiFi module 923, the BT module 925, the GPS module 927, and the NFC module 928 are shown as separated blocks, however, according to an embodiment of the present invention, at least a portion of the cellular module 921, the WiFi module 923, the BT module 925, the GPS module 927, and the NFC module 928 may be included in a single Integrated Circuit (IC) or a single IC package. For example, one or more (for example, a communication processor corresponding to the cellular module 921 and a WiFi processor corresponding to the WiFi module 923) of the processors corresponding to the cellular module 921, the WiFi module 923, the BT module 925, the GPS module 927, and the NFC module 928 may be implemented as single SoC.

The RF module 929 may perform data transmission and reception, for example, transmission and reception of RF signals. The RF module 929 may include a transceiver, a Power Amp Module (PAM), a frequency filter, or a Low Noise Amplifier (LNA). Also, the RF module 929 may further include an element (for example, a conductor or a conducting wire) for transmitting/receiving electronic waves in free air space for wireless communication. In FIG. 9, the cellular module 921, the WiFi module 923, the BT module 925, the GPS module 927, are the NFC module 928 are shown to share the RF module 929, however, according to an embodiment of the present invention, at least one of the cellular module 921, the WiFi module 923, the BT module 925, the GPS module 927, and the NFC module 928 may perform transmission/reception of RF signals through a separate RF module.

The SIM card 924 may be a card including a subscriber identification module, and may be inserted into a slot formed at a specific location of the electronic device. The SIM card 924 may include unique identification information (for example, Integrated Circuit Card Identifier (ICCID)) or subscriber information (for example, International Mobile Subscriber Identity (IMSI)).

The memory 930 (for example, the memory 130 of FIG. 1) may include an internal memory 932 and/or an external memory 934. The internal memory 932 may include at least one of a volatile memory (for example, Dynamic RAM (DRAM), Static RAM (SRAM), Synchronous Dynamic RAM (SDRAM), or the like), or a non-volatile memory (for example, One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, or the like).

According to an embodiment of the present invention, the internal memory 932 may be a Solid State Drive (SSD). The external memory 934 may include a flash drive, for example, Compact Flash (CF), Secure Digital (SD), Micro Secure Digital (Micro-SD), Mini Secure Digital (Mini-SD), extreme Digital (xD), or Memory Stick. The external memory 934 may be functionally connected to the electronic device 901 through various interfaces. According to an embodiment of the present invention, the electronic device 901 may further include a storage device (or storage medium), such as a hard drive.

The sensor module 940 may measure physical quantity, sense an operation state of the electronic device 901, and convert the measured or sensed information into electrical signals. The sensor module 940 may include at least one of a gesture sensor 940A, a gyro sensor 940B, a pressure sensor 940C, a magnetic sensor 940D, an accelerometer 940E, a grip sensor 940F, a proximity sensor 940G, a color sensor 940H (for example, a Red, Green, Blue (RGB) sensor), a biometric sensor 9401, a temperature/humidity sensor 940J, an ambient light sensor 940K, or an Ultra Violet (UV) sensor 940M. Additionally or alternatively, the sensor module 940 may include an E-nose sensor, an electromyography (EMG) sensor, an electroencephalogram (EEG) sensor, an electrocardiogram (ECG) sensor, an Infrared (IR) sensor, an iris sensor, or a fingerprint sensor. The sensor module 940 may further include a control circuit to control at least one sensor included therein.

The input device 950 may include a touch panel 952, a (digital) pen sensor 954, a key 956, or an ultrasonic input device 958. The touch panel 952 may be a capacitive type, a resistive type, an infrared type, or an ultrasonic type. Also, the touch panel 952 may further include a control circuit. If the touch panel 952 is a capacitive type, the touch panel 952 can recognize proximity as well as a direct touch input. The touch panel 952 may further include a tactile layer. In this case, the touch panel 952 may give a user a tactile impression.

The (digital) pen sensor 954 may sense a pen touch input using a method that is the same as or similar to that of receiving a touch input from a user. Also, the pen sensor 954 may sense a pen touch input using a recognition sheet. The key 956 may be a physical button, an optical key, or a keypad. The ultrasonic input device 958 may be a device capable of detecting data by sensing sound waves with a microphone (for example, a microphone 988) in the electronic device 901, through an input tool of generating ultrasonic signals. The ultrasonic input device 958 may enable RF identification (RFID). According to an embodiment of the present invention, the electronic device 901 may receive a user input from an external device (for example, a computer or a server) connected to the electronic device 901, using the communication module 920.

The display 960 (for example, the display 150 of FIG. 1) may include a panel 962, a hologram 964, or a projector 966. The panel 962 may be a Liquid-Crystal Display (LCD) or an Active-Matrix Organic Light-Emitting Diode (AM-OLED). The panel 962 may be implemented to be flexible, transparent, or wearable. The panel 962 may be integrated into the touch panel 952. The hologram 964 may show a 3Dimensional (3D) image in the air using interference of light. The projector 966 may project light onto a screen to display an image. The screen may be located inside or outside the electronic device 901. According to an embodiment of the present invention, the display 960 may further include a control circuit for controlling the panel 962, the hologram 964, or the projector 966.

The interface 970 may include, for example, High-Definition Multimedia Interface (HDMI) 972, a Universal Serial Bus (USB) 974, an optical interface 976, or a D-subminiature (D-sub) 978. The interface 970 may be, for example, included in the communication interface 160 shown in FIG. 1. Additionally or alternatively, the interface 970 may include, for example, a Mobile High-definition Link (MHL) interface, a Secure Digital (SD)/Multi-Media Card (MMC) interface, or an Infrared Data Association (IrDA) interface.

The audio module 980 may convert sound into electronic signals and vice versa. At least one component of the audio module 980 may be, for example, included in the input/output interface 140 shown in FIG. 1. The audio module 980 may process voice information input/output through, for example, a speaker 982, a receiver 984, earphones 986, or the microphone 988.

The camera module 991, which captures still images or moving images, may include one or more images sensors (for example, a front sensor or a rear sensor), lenses, an Image Signal Processor (ISP), or a flash (for example, LED or xenon lamp).

The power management module 995 may manage power of the electronic device 901. The power management 995 may include a Power Management Integrated Circuit (PMIC), a charge IC, or a battery or fuel gauge.

The PMIC may be installed in an IC or a SoC semiconductor. A charging method may be classified into a wired type and a wireless type. The charge IC may charge a battery, and prevent inflow of overvoltage or overcurrent from a charger. According to an embodiment of the present invention, the charge IC may include a charge IC for at least one of a wired charging method and a wireless charging method. The wireless charging method may be a magnetic resonance method, a magnetic induction method, or an electromagnetic wave method, and in order to perform the wireless charging method, the charge IC may include an additional circuit, for example, a coil loop, a resonance circuit, or a rectifier.

The battery gauge may measure, for example, a level of a battery 996, and a voltage, a current, or a temperature during charging. The battery 996 may store or generate electricity, and supply power to the electronic device 901 using the stored or generated electricity. The battery 996 may be a rechargeable battery or a solar battery.

The indicator 997 may display a specific state (for example, a booting state, a message state, or a battery level) of the electronic device 901 or a part (for example, the AP 910) of the electronic device 901. The motor 998 may convert electrical signals into mechanical vibration. The electronic device 901 may include a processor (for example, GPU) for supporting a mobile TV. The processor may process media data based on a standard of Digital Multimedia Broadcasting (DMB), Digital Video Broadcasting (DVB), media flow, or the like.

Each of the above-described units of the electronic device 901 may be configured with one or more components, and the units may be termed according to a kind of the corresponding electronic device. The electronic device 901 may include at least one of the above-described units. Also, the electronic device 901 may omit some of the above-described units or further include another unit(s). Furthermore, some of the units of the electronic device 901 may be combined to constitute an entity that performs the same functions as the corresponding units.

The term “module”, as used herein, may refer to a unit including, for example, hardware, software, firmware, or a combination thereof. The term “module” may be interchangeably used with another term, such as “unit”, “logic”, “logical block”, “component”, or “circuit”. The “module” may be a minimum unit or a part of components integrated into one body. Also, the “module” may be a minimum unit or a part for performing one or more functions. The “module” may be implemented mechanically or electronically. For example, the “module” may include at least one of an Application-Specific Integrated Circuit (ASIC) chip, Field-Programmable Gate Arrays (FPGAs), or a programmable-logic device, which performs certain operations, already developed or to be developed in future.

According to an embodiment of the present invention, at least one part of an apparatus (for example, modules or their functions) or method (for example, operations) may be implemented as an instruction stored in computer-readable storage media, for example, in the form of a programming module. When the instruction is executed by one or more processors (for example, the processor 120), the one or more processors may perform a function corresponding to the instruction. The computer-readable storage media may be, for example, the memory 130. At least one part of the programming module may be implemented (for example, executed) by the processor 120. At least one of the programming modules may include a module, a program, a routine, sets of instructions, or a processor for performing one or more functions.

The computer-readable storage media may include magnetic media (for example, a hard disk, a floppy disk, and a magnetic tape), optical media (for example, Compact Disc Read Only Memory (CD-ROM) and Digital Versatile Disc (DVD)), magneto-optical media (for example, floptical disk), and hardware device (for example, Read Only Memory (ROM), and Random Access Memory (RAM), and flash memory) specifically configured to store and perform a program instruction (for example, a programming module). Also, the programming instruction may include a high-level language code that can be executed by a computer using an interpreter, as well as a machine code that is created by a compiler. The hardware device may be configured to operate as at least one software module for performing operations according to various embodiments of the present invention, and vice versa.

The module or the programming module may include at least one of the aforementioned components, omit a part of the aforementioned components, or further include another component. The module, the programming module, or operations that are performed by another component may be executed sequentially, in parallel, repeatedly, or heuristically. Also, a part of the operations may be executed in a different order, may be omitted, or may add another operation.

According to an embodiment of the present invention, in a storage medium that stores commands, the commands are set to enable at least one processor to perform at least one operation when the commands are executed by the at least one processor. The at least one operation may include: making a voice call during data transmission and reception to and from an external electronic device; determining whether a communication status is sufficient to perform data transmission and reception while making the voice call; and stopping data transmission and reception if it is determined that the communication status is not sufficient to perform the data transmission and reception while making the voice call.

While the invention has been shown and described with reference to certain embodiments thereof, it will be understood by those skilled in the art that various changes in form and detail may be made therein without departing from the spirit and scope of the invention as defined by the appended claims and their equivalents.

What is claimed is:

1. An electronic device comprising:
a communication interface configured to communicate with an external electronic device; and
a control module configured to determine whether a communication status is sufficient to perform data transmission and reception to and from the external electronic device while making a voice call, and to stop the data transmission and reception if the control module determines that the communication status is not sufficient to perform the data transmission and reception while making the voice call.

2. The electronic device of claim 1, wherein, if the control module determines that the communication status is sufficient to perform the data transmission and reception while making the voice call, the control module is further configured to perform the data transmission and reception while making the voice call.

3. The electronic device of claim 1, wherein the control module determines whether the communication status is sufficient to perform the data transmission and reception while making the voice call, if the electronic device enters a waiting state.

4. The electronic device of claim 1, wherein the control module is configured to perform at least one of: determining whether a time taken to receive a first response message, notifying that data has been received, from the external electronic device does not exceed a predetermined threshold time; and determining whether a number of times that a second response message, notifying that the data has not been received, is received from the external electronic device is less than or equal to a predetermined threshold number of times.

5. The electronic device of claim 4, wherein the control module is further configured to determine that the communication status is sufficient to perform the data transmission and reception while making the voice call if the time taken to receive the first response message does not exceed the predetermined threshold time.

6. The electronic device of claim 4, wherein the control module is further configured to determine that the communication status is sufficient to perform the data transmission and reception while making the voice call if the number of times that the second response message is received is less than or equal to the predetermined threshold number of times.

7. The electronic device of claim 1, wherein the control module is further configured to transmit a disconnection request message for stopping the data transmission and reception, to the external electronic device.

8. The electronic device of claim 7, wherein the control module is further configured to determine whether a signal quality of a network is sufficient to perform the data transmission and reception, and to resume the data transmission and reception if the signal quality of the network is sufficient to perform the data transmission and reception.

9. The electronic device of claim 8, wherein the control module determines whether the signal quality of the network is sufficient to perform the data transmission and reception by performing at least one of: determining whether a processing speed of the network is greater than a threshold speed; and determining whether a throughput of the network is greater than a threshold throughput.

10. The electronic device of claim 9, wherein the control module is further configured to determine that the signal quality of the network is sufficient to perform the data transmission and reception if the processing speed of the network is greater than the threshold speed.

11. The electronic device of claim 9, wherein the control module is further configured to determine that the signal quality of the network is sufficient to perform the data transmission and reception if the throughput of the network is greater than the threshold throughput.

12. A method of using an electronic device, the method comprising the steps of:
making a voice call during data transmission and reception to and from an external electronic device;
determining whether a communication status is sufficient to perform the data transmission and reception while making the voice call; and
stopping the data transmission and reception if the communication status is not sufficient to perform the data transmission and reception while making the voice call.

13. The method of claim 12, further comprising performing the data transmission and reception while making the voice call if the communication status is sufficient to perform the data transmission and reception while making the voice call.

14. The method of claim 12, wherein it is determined whether the communication status is sufficient to perform the data transmission and reception while making the voice call, if the electronic device enters a waiting state.

15. The method of claim 12, wherein determining whether the communication status is sufficient to perform the data transmission and reception while making the voice call comprises at least one of:
determining whether a time taken to receive a first response message from the external electronic device does not exceed a predetermined threshold time, the first response message notifying that the data has been received at the external electronic device; and
determining whether a number of times that a second response message is received from the external electronic device is less than or equal to a predetermined threshold number of times, the second response message notifying that the data has not been received at the external electronic device.

16. The method of claim 15, wherein the communication status is not sufficient to perform the data transmission and reception while making the voice call if the time taken to receive the first response message exceeds the predetermined threshold time.

17. The method of claim 15, wherein the communication status is not sufficient to perform the data transmission and reception while making the voice call if the number of times that the second response message is received is greater than the predetermined threshold number of times.

18. The method of claim 12, further comprising transmitting a disconnection request message for stopping the data transmission and reception, to the external electronic device.

19. The method of claim 18, further comprising:
determining whether a signal quality of a network is sufficient to perform the data transmission and reception; and
resuming the data transmission and reception if the signal quality of the network is sufficient to perform the data transmission and reception.

20. The method of claim 19, wherein determining whether the signal quality of the network is sufficient to perform the data transmission and reception comprises at least one of:
determining whether a processing speed of the network is greater than a threshold speed; and
determining whether a throughput of the network is greater than a threshold throughput.

21. The method of claim 20, wherein the signal quality of the network is sufficient to perform the data transmission and reception if the processing speed of the network is greater than the threshold speed.

22. The method of claim 20, wherein the signal quality of the network is sufficient to perform the data transmission and reception if the throughput of the network is greater than the threshold throughput.

23. A computer-readable recording medium storing computer-readable instructions, recorded with a program for executing operations of:
making a voice call during data transmission and reception to and from an external electronic device;
determining whether a communication status is sufficient to perform the data transmission and reception while making the voice call; and
stopping the data transmission and reception if the communication status is not sufficient to perform the data transmission and reception while making the voice call.
